(19) United States
(12) Patent Application Publication
(10) Pub. No.: US 2014/0018138 A1
(43) Pub. Date: Jan. 16, 2014

(54) CARD GAMES WITH HYBRID RULES BASED ON BACCARAT, POKER AND BLACKJACK

(71) Applicant: Ronald Keith Sloan, St. Kikda (AU)

(72) Inventor: Ronald Keith Sloan, St. Kikda (AU)

(73) Assignee: Gaming Innovations Pty Ltd, Bendigo, VIC (AU)

(21) Appl. No.: 13/979,335

(22) PCT Filed: Jan. 14, 2012
(86) PCT No.: PCT/IB12/00047

§ 371 Date: Sep. 30, 2013

(30) Foreign Application Priority Data
Jan. 14, 2011 (AU) 2011900132

(51) Int. Cl. G07F 17/32

(52) U.S. Cl. CPC G07F 17/3293
USPC 463/11; 273/292

(57) ABSTRACT

A method for playing a card game with hybrid rules, which includes receiving wagers and dealing cards to form two- or three-card hands based on blackjack or poker wagering and dealing rules, valuing and ranking the two- or three-card hands based on modified baccarat valuing and ranking rules wherein a three-card hand outranks a two-card hand of equal sum modulo ten value, and resolving the wagers based on the valuing and ranking of the two- or three-card hands.

### FIELD

The present invention relates to card games with hybrid rules based on baccarat, poker and blackjack.

### BACKGROUND

Baccarat, blackjack and poker are popular card games played in casinos (or other gaming venues) and online. Baccarat has relatively simple card dealing and wagering rules with easily understood rules for valuing and ranking hands. In baccarat, each of the cards from ace to nine has a point value equal to its rank or spot value, and the remaining cards (ten, jack, queen, and king) have a point value of zero. The total point value of hands in baccarat is determined by summing modulo ten the point value of the constituent cards. Taking the total modulo ten means disregarding the first digit in any total of ten or more. For example, a hand consisting of three and four is worth seven (3+4=7). A hand consisting of seven and nine is worth six (7+9=16=6), the first digit being dropped as the total is higher than ten. A hand consisting of six and four is worth zero (6+4=0). In baccarat, there are a total of ten ranked hand totals with the highest ranked hand being any two or three card combination having a total (or sum modulo ten) that totals nine. The total number of cards used to obtain the total is irrelevant in conventional baccarat, and as such, a two-card total of nine has the same ranking as a three-card total of nine.

However, baccarat traditionally has only three possible outcomes on which players can wager, i.e. player, banker and tie. In addition, since all wagers must be placed before cards are dealt, traditional variants of baccarat do not allow for adversarial card play between players and/or against the dealer. Furthermore, conventional baccarat rules do not allow for player participation or additional decision making once the game begins, as a standard series of rules known as the tableau governs the outcome of each game. The tableau determines when a two-card total for either the player or bankers hand must either stand or draw another card. These decisions are fixed by the house and do not allow for any player decision-making whatsoever.

Compared to baccarat, blackjack and poker have more complex card dealing and wagering rules that allow more varied player-against-player and/or player-against-dealer card play, and also provide more possible outcomes and wagering options. However, blackjack and poker have more complicated hand valuing and ranking rules than baccarat.

In view of the foregoing, there is a need to provide card games with hybrid rules that combine advantageous aspects of baccarat with those of blackjack and poker to increase the strategy, skill, enjoyment, and excitement of card games in casinos and online.

### SUMMARY

According to the present invention, there is provided a method for playing a card game with hybrid rules, which includes receiving wagers and dealing cards to form two- or three-card hands based on blackjack or poker wagering and dealing rules, valuing and ranking the two- or three-card hands based on modified baccarat valuing and ranking rules wherein a three-card hand outranks a two-card hand of equal sum modulo ten value, and resolving the wagers based on the valuing and ranking of the two- or three-card hands.

The valuing and ranking of the two- or three-card hands can be based on the modified baccarat values and rankings set out in the following Table 1:

TABLE 1

| Rank | Hand/Value |
|---|---|
| 1st | 333 |
| 2nd | 3-Card 9 |
| 3rd | 2-Card 9 |
| 4th | 3-Card 8 |
| 5th | 2-Card 8 |
| 6th | 3-Card 7 |
| 7th | 2-Card 7 |
| 8th | 3-Card 6 |
| 9th | 2-Card 6 |
| 10th | 3-Card 5 |
| 11th | 2-Card 5 |
| 12th | 3-Card 4 |
| 13th | 2-Card 4 |
| 14th | 3-Card 3 |
| 15th | 2-Card 3 |
| 16th | 3-Card 2 |
| 17th | 2-Card 2 |
| 18th | 3-Card 1 |
| 19th | 2-Card 1 |
| 20th | 3-Card 0 |
| 21st | 2-Card 0 |

When the card game is played player-against-dealer, the receiving wagers and dealing cards can be based on blackjack wagering and dealing rules. When the card game is played player-against-player (or peer-to-peer), the receiving wagers and dealing cards can be based on poker wagering and dealing rules.

The method may be implemented as a live table game or an online gaming application.

The present invention also provides a machine-readable storage medium having instructions stored thereon which when executed by a processor causes the processor to perform operations including receiving wagers and dealing cards to form two- or three-card hands based on blackjack or poker wagering and dealing rules, valuing and ranking the two- or three-card hands based on modified baccarat valuing and ranking rules wherein a three-card hand outranks a two-card hand of equal sum modulo ten value, and resolving the wagers based on the valuing and ranking of the two- or three-card hands.

The present invention further provides an electronic device including a user input, a display, a processor, and a memory having instructions therein which when executed by the processor perform operations via the user input and the display which include receiving wagers and dealing cards to two- or three-card hands based on blackjack or poker wagering and dealing rules, valuing and ranking the two- or three-card hands based on modified baccarat valuing and ranking rules wherein a three-card hand outranks a two-card hand of equal sum modulo ten value, and resolving the wagers based on the valuing and ranking of the two- or three-card hands.

The electronic device can be selected from a computer, an electronic game table, a gaming machine, a mobile phone, and a smartphone.

### BRIEF DESCRIPTION OF DRAWINGS

Embodiments of the invention will now be described by way of example only with reference to the accompanying drawing, in which:

FIG. 1 is a process diagram flow of a method for playing a card game with hybrid rules according to one embodiment of the present invention.

### DETAILED DESCRIPTION

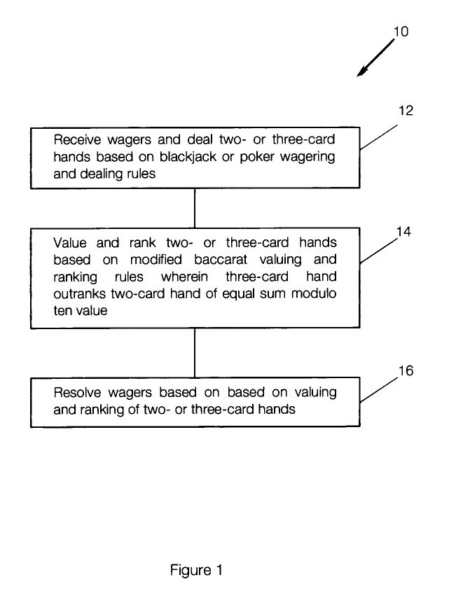

FIG. 1 illustrates a method 10 for playing a card game with hybrid rules according to one embodiment of the present invention. The method starts at step 12 by receiving wagers from, and dealing cards to, one or more players to form two- or three-card hands based on blackjack or poker wagering and dealing rules. For example, when the card game is played player-against-dealer, the receiving wagers and dealing cards are based on blackjack wagering and dealing rules. When the card game is played player-against-player, the receiving wagers and dealing cards are, for example, based on poker wagering and dealing rules, and the cards can be dealt from either a single 52 card deck or multiple decks with or without jokers. The poker wagering and dealing rules are, for example, draw poker, stud poker, show poker, and hold'em poker. The wagering and dealing rules optionally allow secondary, side or jackpot bets, such as progressive jackpot bets, to be made by players in the manner of secondary, side or jackpot wagering in poker and blackjack. Other equivalent wagering and dealing rules of other variations of poker and blackjack may also be used.

The method 10 moves to step 14 where the two- or three-card hands are valued and ranked based on modified baccarat valuing and ranking rules wherein a three-card hand outranks a two-card hand of equal sum modulo ten value. For example, valuing and ranking of the two- or three-card hands are based on the table of modified baccarat values and rankings set out in Table 1 above. Other equivalent tables of modified baccarat values and rankings may also be used. For example, Table 1 is optionally modified by assigning a special three-card hand the highest ranking even if its modulo ten sum is greater or less than nine. In one variant of Table 1 above, the highest-ranking three-card hand “333” is replaced by another special highest-ranking three-card which is a three of a kind hand, such as three eights (“888”). The method 10 ends at step 16 by resolving the wagers based on the above valuing and ranking of the two- or three-card hands, and paying the winning player.

The method of the invention can be implemented as a live table game in a casino (or other gaming venue) and performed manually using physical cards, non-electronic gaming tables and physical wagering chips. The method may also be implemented in computer software and performed electronically using virtual cards on networked or standalone electronic devices selected from computers, electronic game tables, gaming machines, mobile phones, and smartphones. Other equivalent electronic devices may also be used. The method may also be implemented partially manually and electronically, for example, on a hybrid electronic gaming table with physical cards.

The method of the invention may also be implemented as an online gaming application in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The invention will now be described in more detail by reference to the following example, which is illustrative only and does not limit the scope of the invention.

### EXAMPLE

In a casino live table game example, players play their individual hand against the dealer in a similar manner to the play of blackjack. The game is played in a bricks and mortar casino on a table with a layout similar to a standard blackjack or mini-baccarat table. It may also be played on a standard big baccarat style table. It is dealt from an eight-deck shoe containing a specified number of standard decks. A six-deck shoe may also be used.

In common with conventional baccarat, the player's essential object is to end up with a hand whose total is closer to nine than their opponent, who is the casino dealer in this table game example. One differentiating aspect of the game is that a three-card hand beats a two-card hand with the same total.

The game is dealt in a similar fashion to blackjack, and on a similar table with a number of individual player boxes and one area for the house hand. The players are each playing individually against the house hand that is played by the dealer according to the defined house rules. The dealer has no choice or discretion in the play of the house hand. Two cards are dealt initially to each active player (those who have placed a wager in their designated primary betting area) and one card is initially dealt face up to the dealer. The player cards may be dealt face up in front of the player (for faster low to medium limit games) or possibly face down in the case of the more ritualistic high limit games. In the lower limit games, the players may not touch the playing cards which will be subsequently shuffled and re-dealt, whereas in the high limit games the player may squeeze their cards which will be used only once.

Once each active player has been dealt their initial two cards and the dealer's initial card has been dealt face up, each player in turn will be asked to play their hand by either:
standing on their initial two cards, taking no further card and remaining active in the hand; or
hitting by drawing a third card and remaining active in the game.
   How players play their hand is completely up to them; they are not bound by any set of total dependent rules.

Once every player has acted on their hand, the dealer deals the house hand a second card face up and then either:
hits by taking a third card if the two cards are both threes; or otherwise
hits by taking a third card if the two card total is five or less; and
stands if the two-card total is six or more.

The player and house hands are then valued and ranked according to the following modified baccarat valuing and ranking rules.
The highest-ranking hand is a three-card hand consisting of three threes (“333”). It beats any other hand. A player hand of 333 beats a dealer hand of 333. Otherwise, the ranking is determined by the total point value of the hand and by the number of cards (two or three) that comprise the hand.
If two hands have a different point total, the winning hand is that which has the higher point total.
If a two-card hand and a three-card hand have the same point total, the winning hand is the three-card hand.

Two hands are of equal rank and constitute a “tie” if both hands have the same point total and the same number of cards except for the case when both hands contain three threes. The above rules give the hierarchy in Table 1 above. The rank of each player hand is compared to the rank of the dealer's hand using the above hierarchy. The possible outcomes of the comparison are:
player wins: if the rank of the active player hand is higher than that of the dealer, the dealer pays the player an amount which is a designated multiple of the player's wager and the player also retains their original wager. When this occurs, the resolution of the wager depends on which variant of the game rules are being used;
house wins: if the rank of the active player hand is less than that of the dealer, the dealer collects the original player wager;
house and player tie: a player hand of 333 beats a dealer hand of 333.

Otherwise, if the rank of the player hand and the dealer hand are the same, the hand is a “tie” (i.e. the hands have the same point total and the same number of cards). When this occurs, the resolution of the wager also depends on which variant of the game rules is being used. The game has many possible variants which differ in their payout structure, specifically with respect to:
the odds paid for a winning player bet; and
the treatment of “ties”.

The odds paid for a winning player bet may be dependent on the total point value of the winning player hand. Ties can be treated in various ways as follows:
they may be treated as a standoff; or
they may be won by the house; or
they may be won by the player and paid at designated odds.
   The treatment of ties may also be total dependent. Different variants are tailored to produce a desired house edge and to appeal to a particular target market.

The outcome of the primary bet is dependent on the result of comparing the player's final hand with that of the dealer as discussed above. Associated with this casino example of the game are a number of possible side bets. These side bets fall into two categories, specifically:
those which are decided by the outcome of the primary bet; and
those which depend on the composition of the cards dealt.
   The odds and probabilities of primary, side and jackpot bets can be calculated using conventional mathematical techniques.

The above example of the invention provides a hybrid card game with increased strategy, skill, enjoyment, and excitement of card game play.

The above example and embodiments have been described by way of example only and modifications are possible within the scope of the claims that follow.

1. A method for playing a card game with hybrid rules, the method comprising:
receiving wagers and dealing cards to form two- or three-card hands based on blackjack or poker wagering and dealing rules, valuing and ranking the two- or three-card hands based on modified baccarat valuing and ranking rules wherein a three-card hand outranks a two-card hand of equal sum modulo ten value, and resolving the wagers based on the valuing and ranking of the two- or three-card hands.

2. The method according to claim 1, wherein the valuing and ranking of the two- or three-card hands are based on the modified baccarat values and rankings set out in the following table:

| Rank | Hand/Value |
|---|---|
| 1st | 333 |
| 2nd | 3-Card 9 |
| 3rd | 2-Card 9 |
| 4th | 3-Card 8 |
| 5th | 2-Card 8 |
| 6th | 3-Card 7 |
| 7th | 2-Card 7 |
| 8th | 3-Card 6 |
| 9th | 2-Card 6 |
| 10th | 3-Card 5 |
| 11th | 2-Card 5 |
| 12th | 3-Card 4 |
| 13th | 2-Card 4 |
| 14th | 3-Card 3 |
| 15th | 2-Card 3 |
| 16th | 3-Card 2 |
| 17th | 2-Card 2 |
| 18th | 3-Card 1 |
| 19th | 2-Card 1 |
| 20th | 3-Card 0 |
| 21st | 2-Card 0 |

3. The method according to claim 1, wherein, the card game is played player-against-dealer, and the receiving wagers and dealing cards are based on blackjack wagering and dealing rules.

4. The method according to claim 1, wherein, the card game is played player-against-player, and the receiving wagers and dealing cards are based on poker wagering and dealing rules.

5. The method according to claim 1, wherein the method is implemented as a live table game or an online gaming application.

6. A machine-readable storage medium having instructions stored thereon which when executed by a processor causes the processor to perform operations including receiving wagers and dealing cards to form two- or three-card hands based on blackjack or poker wagering and dealing rules, valuing and ranking the two- or three-card hands based on modified baccarat valuing and ranking rules wherein a three-card hand outranks a two-card hand of equal sum modulo ten value, and resolving the wagers based on the valuing and ranking of the two- or three-card hands.

7. An electronic device, comprising:
a user input device;
a display;
a processor in communication with the user input device and the display; and
a memory readable by the processor, the memory having instructions therein which when executed by the processor perform operations via the user input and the display which include receiving wagers and dealing cards to two- or three-card hands based on blackjack or poker wagering and dealing rules, valuing and ranking the two- or three-card hands based on modified baccarat valuing and ranking rules wherein a three-card hand outranks a two-card hand of equal sum modulo ten value, and resolving the wagers based on the valuing and ranking of the two- or three-card hands.

8. The electronic device according to claim 7, wherein the electronic device is selected from a computer, an electronic game table, a gaming machine, a mobile phone, and a smartphone.

9. The method according to claim 2, wherein, the card game is played player-against-dealer, and the receiving wagers and dealing cards are based on blackjack wagering and dealing rules.

10. The method according to claim 2, wherein, the card game is played player-against-player, and the receiving wagers and dealing cards are based on poker wagering and dealing rules.
